(19) United States
(12) Patent Application Publication
(10) Pub. No.: US 2026/0213805 A1
(43) Pub. Date: Jul. 23, 2026

(54) REFERENCE VALUE REPORTING FOR ARTIFICIAL INTELLIGENCE ENABLED CHANNEL STATE INFORMATION REPORTING FRAMEWORK

(71) Applicant: Lenovo (Singapore) Pte. Limited, Singapore (SG)

(72) Inventors: Ahmed Hindy, Aurora, IL (US); Vahid Pourahmadi, München (DE); Venkata Srinivas Kothapalli, Aurora, IL (US); Vijay Nangia, Woodridge, IL (US)

(73) Assignee: Lenovo (Singapore) Pte. Limited, Singapore (SG)

(21) Appl. No.: 19/138,999

(22) PCT Filed: Dec. 5, 2023
(86) PCT No.: PCT/IB2023/062275

§ 371 Date: Jun. 13, 2025

Related U.S. Application Data
(60) Provisional application No. 63/387,872, filed on Dec. 16, 2022.

(51) Int. Cl. H04B 7/06; H04W 72/044

(52) U.S. Cl. CPC H04B 7/0626; H04B 7/0632; H04W 72/044

(57) ABSTRACT

Various aspects of the present disclosure relate to reference value reporting for artificial intelligence enabled channel state information reporting framework. An artificial intelligence/machine learning (AI/ML)-based CSI feedback mechanism is described. A node (e.g., a UE) that deploys an encoder of an AI/ML model generates a CSI report that includes a CSI part (e.g., CSI feedback) and a reference value part. The reference value part is a pre-determined reference sequence that is also known to the node (e.g., a network entity) that deploys a decoder of the AI/ML model. The node that deploys the encoder transmits the CSI report to the node that deploys the decoder. By using the reference value in the CSI report, the node that deploys the decoder can quantify a CSI reconstruction error, and hence adjust a nominal CQI value fed back by the node with the encoder side.

### RELATED APPLICATION

This application claims priority to U.S. Patent Application Ser. No. 63/387,872 filed Dec. 16, 2022 entitled “REFERENCE VALUE REPORTING FOR ARTIFICIAL INTELLIGENCE ENABLED CHANNEL STATE INFORMATION REPORTING FRAMEWORK,” the disclosure of which is incorporated by reference herein in its entirety.

### TECHNICAL FIELD

The present disclosure relates to wireless communications, and more specifically to reference value reporting for artificial intelligence (AI) enabled channel state information (CSI) reporting framework.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In the wireless communications system, CSI feedback can be transmitted from a UE to a base station (e.g., a gNB). The CSI feedback provides the base station with an indication of the quality of a channel at a particular time.

### SUMMARY

The present disclosure relates to methods, apparatuses, and systems that support reference value reporting for artificial intelligence enabled channel state information reporting framework. An artificial intelligence/machine learning (AI/ML)-based CSI feedback mechanism is described. A node (e.g., a UE) that deploys an encoder of an AI/ML model generates a CSI report that includes a CSI part (e.g., CSI feedback) and a reference value part. The reference value part is a pre-determined reference sequence that is also known to the node (e.g., a network entity) that deploys a decoder of the AI/ML model. The node that deploys the encoder transmits the CSI report to the node that deploys the decoder. By using the reference value in the CSI report, the node that deploys the decoder can quantify a CSI reconstruction error, and hence adjust a nominal channel quality indicator (CQI) value fed back by the node with the encoder side.

Some implementations of the method and apparatuses described herein may further include to: receive, from a network entity, a first signaling corresponding to a CSI reference signal (RS); generate CSI feedback parameters based on a two-sided AI model including an encoder part and a decoder part, wherein the encoder part is deployed at the apparatus; and transmit, to the network entity, a second signaling indicating a CSI report that includes an output of the encoder part, wherein the output of the encoder part includes at least one of a CSI part and a reference value part.

In some implementations of the method and apparatuses described herein, the reference value part is a sequence of bits corresponding to a subset of the output of the encoder part, and wherein a corresponding input of the encoder part is a pre-determined quantity. Additionally or alternatively, the pre-determined quantity is a vector corresponding to a pre-determined eigenvector of a channel-based matrix. Additionally or alternatively, the pre-determined quantity is a vector of channel coefficients corresponding to a spatial-domain basis index, a frequency-domain basis index, a time-domain basis index, or a combination thereof. Additionally or alternatively, the pre-determined quantity is selected from a set of pre-configured quantities. Additionally or alternatively, the reference value part is a sequence of bits corresponding to a measure of a quantity based on at least one parameter in the CSI part. Additionally or alternatively, the reference value part is not a subset of the output of the encoder part. Additionally or alternatively, the reference value part is equivalent to a subset of parameters of a set of parameters corresponding to the CSI part, and wherein the subset of parameters are an input of the encoder part. Additionally or alternatively, the reference value part is a measure of a phase value based on a function of one or more channel-based parameters in the CSI part. Additionally or alternatively, the reference value part corresponds to a combination of at least one parameter of a set of parameters of the CSI part. Additionally or alternatively, the CSI report comprises a channel quality indicator (CQI) value that is based on a fully-matched encoder and decoder pair, and a correction factor corresponding to the CQI value is based on a comparison of the CSI part with the reference value part. Additionally or alternatively, the CSI report is utilized for AI-based model monitoring, the AI-based model monitoring is based on a comparison of the CSI part with the reference value part. Additionally or alternatively, the decoder part is deployed in the network entity.

Some implementations of the method and apparatuses described herein may further include to: transmit, to a UE, a first signaling corresponding to a CSI RS; receive, from the UE, a second signaling indicating a CSI report that includes an output of an encoder part of a two-sided AI model having the encoder part and a decoder part, wherein the output of the encoder part includes at least one of a CSI part and a reference value part, and wherein the decoder part is deployed at the apparatus.

In some implementations of the method and apparatuses described herein, the reference value part is a sequence of bits corresponding to a subset of the output of the encoder part, and wherein a corresponding input of the encoder part is a pre-determined quantity. Additionally or alternatively, the pre-determined quantity is a vector corresponding to a pre-determined eigenvector of a channel-based matrix. Additionally or alternatively, the pre-determined quantity is a vector of channel coefficients corresponding to a spatial-domain basis index, a frequency-domain basis index, a time-domain basis index, or a combination thereof. Additionally or alternatively, the pre-determined quantity is selected from a set of pre-configured quantities. Additionally or alternatively, the reference value part is a sequence of bits corresponding to a measure of a quantity based on at least one parameter in the CSI part. Additionally or alternatively, the reference value part is not a subset of the output of the encoder part. Additionally or alternatively, the reference value part is equivalent to a subset of parameters of a set of parameters corresponding to the CSI part, and wherein the subset of parameters are an input of the encoder part. Additionally or alternatively, the reference value part is a measure of a phase value based on a function of one or more channel-based parameters in the CSI part. Additionally or alternatively, the reference value part corresponds to a combination of at least one parameter of a set of parameters of the CSI part. Additionally or alternatively, the CSI report comprises a CQI value that is based on a fully-matched encoder and decoder pair, and wherein a correction factor corresponding to the CQI value based on a comparison of the CSI part with the reference value part. Additionally or alternatively, the method and apparatuses are to use the CSI report for AI-based model monitoring based on a comparison of the CSI part with the reference value part. Additionally or alternatively, the encoder part is deployed in the UE.

### BRIEF DESCRIPTION OF THE DRAWINGS

FIG. 1 illustrates an example of a wireless communications system that supports reference value reporting for artificial intelligence enabled channel state information reporting framework in accordance with aspects of the present disclosure.

FIG. 2 illustrates an aperiodic trigger state defining a list of CSI report settings.

FIG. 3 illustrates an information element pertaining to CSI reporting.

FIG. 4 illustrates an information element for radio resource control (RRC) configuration for wireless resources.

FIG. 5 illustrates a scenario for partial CSI omission for physical uplink shared channel (PUSCH)-based CSI.

FIG. 6 illustrates an example of a two-sided model with an encoder part at a first node and a decoder part at a second node in accordance with aspects of the present disclosure.

FIGS. 7 and 8 illustrate an example of a block diagram of a device that supports reference value reporting for artificial intelligence enabled channel state information reporting framework in accordance with aspects of the present disclosure.

FIGS. 9 through 13 illustrate flowcharts of methods that support reference value reporting for artificial intelligence enabled channel state information reporting framework in accordance with aspects of the present disclosure.

### DETAILED DESCRIPTION

CSI feedback in frequency-division duplexing (FDD) networks is reported by the UE to the network, where the CSI feedback is compressed via transformation of the channel over the spatial domain, frequency domain, or both, with pre-determined sets of spatial and frequency basis vectors, respectively. In addition to conventional CSI feedback mechanisms, artificial intelligence/machine learning (AI/ML)-enabled CSI acquisition schemes may be used. These AI/ML-enabled schemes would provide some feedback from the UE to the network corresponding to CSI components that cannot be inferred from the AI/ML model, e.g., CSI components that are statistically independent over time and hence cannot be inferred from the training data.

One use of AI/ML in CSI acquisition is via two-sided models, in which an encoder part and a decoder part of an autoencoder structure are applied in different nodes (e.g., a UE and a network entity). Unless the model training is centralized, e.g., a same node trains the encoder and decoder parts of the autoencoder, the recovered CSI data at the decoder side may be mismatched with the target CSI data at the encoder side. Given that, the CQI corresponding to the CSI data may be mismatched, leading to significant degradation in performance. Accordingly, an AI/ML-based CSI feedback mechanism is discussed in which a pre-determined reference sequence is transmitted as part of the CSI report so that the node with the decoder side can quantify the CSI reconstruction error, and hence adjust a nominal CQI value fed back by the node with the encoder side. A similar approach can be used for AI model performance monitoring and adaptation as well.

One solution for providing CSI feedback is one-sided AI-based CSI feedback, e.g., the model training and model deployment are based on the same node. No model specific parameters need to be explicitly signaled across the communication nodes. However, one-sided AI/ML models do not exploit the fullest advantages of AI/ML, since the AI/ML enhancement would be limited to parameter value update and not into the codebook structure, otherwise the codebook structure needs to be signaled as part of the CSI report.

Another solution for providing CSI feedback is two-sided AI-based CSI feedback with centralized model training and explicit signaling of the AI model configuration and codebook structure. However, this solution has significant CSI feedback overhead corresponding to the explicit/uncompressed CSI feedback.

Another solution for providing CSI feedback is two-sided AI-based CSI feedback with distributed model training, e.g., encoder and decoder parts of a CSI auto-encoder are designed separately. However, this solution has ambiguity in CSI accuracy based on the extent of the mismatch between the encoder and decoder parts, in turn leading to ambiguity in the CQI.

The techniques discussed herein feed back a pre-determined reference vector as part of the encoded part of the CSI report. The pre-determined reference vector is known to (or can be determined) by the node with the encoder part as well as the node with the decoder part. The node with the decoder part decodes the received reference vector and compares the decoded reference vector to the known reference vector to quantify the CSI reconstruction error. Quantifying the reconstruction error can help readjust the CQI value, enhance the model monitoring performance, enhance the model adaptation performance, and so forth.

The techniques discussed herein also report a set of parameter values corresponding to a metric that measures one or more of a relative amplitude and a relative phase between two encoded CSI components, e.g., one or more of phase difference and cosine similarity between two channel eigenvectors. The node with the decoder part can then compare the measured metric value after decoding with the reported nominal metric value to quantify the reconstruction error.

Aspects of the present disclosure are described in the context of a wireless communications system. Aspects of the present disclosure are further illustrated and described with reference to device diagrams and flowcharts.

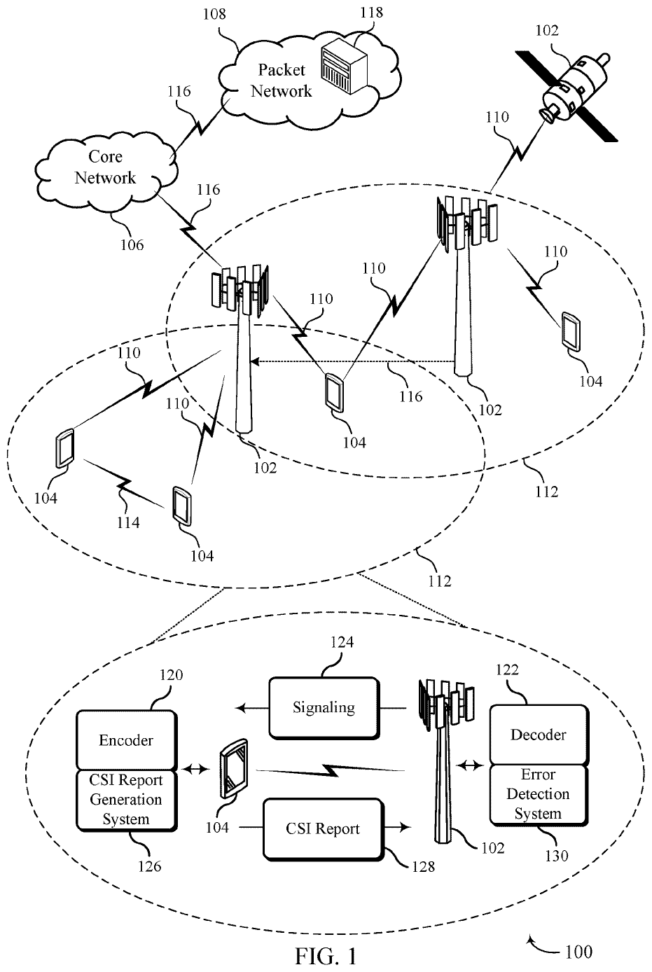

FIG. 1 illustrates an example of a wireless communications system 100 that supports reference value reporting for artificial intelligence enabled channel state information reporting framework in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHZ-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The UE 104 deploys (e.g., implements) an encoder 120 of an AI/ML model and the network entity 102 deploys (e.g., implements) a decoder 122 of the AI/ML model. Additionally or alternatively, the network entity 102 includes deploys the encoder 120 and the UE 104 deploys the decoder 122. The UE 104 receives a signaling 124 and a CSI report generation system 126 generates a CSI report 128 based on the CSI RS corresponding to the signaling 124. The CSI report 128 includes a CSI part (e.g., CSI feedback) and a reference value part. The reference value part is a pre-determined reference sequence that is also known to the network entity 102. The network entity 102 receives the CSI report 128 and an error detection system 130 can quantify, by using the reference value in the CSI report 128, a CSI reconstruction error, and hence adjust a nominal CQI value fed back in the CSI report 128.

Communication between devices discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of a physical downlink shared channel (PDSCH), a physical downlink control channel (PDCCH), a PUSCH, a physical uplink control channel (PUCCH), radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

In some wireless communications systems, details are provided for NR Type-II codebook. For instance, assume that a gNB is equipped with a two-dimensional (2D) antenna array with N₁, N₂ antenna ports per polarization placed horizontally and vertically and communication occurs over N₃ Precoder Matrix Indicator (PMI) sub-bands. A PMI subband can consist of a set of resource blocks, each resource block consisting of a set of subcarriers. In such case, 2N₁N₂ Channel State Information (CSI)-Reference Signal (RS) ports can be utilized to enable downlink (DL) channel estimation with high resolution for NR Rel. 15 Type-II codebook. In order to reduce the uplink (UL) feedback overhead, a Discrete Fourier transform (DFT)-based CSI compression of the spatial domain can be applied to L dimensions per polarization, where L<N₁N₂. In the sequel the indices of the 2L dimensions can be referred as the Spatial Domain (SD) basis indices. The magnitude and phase values of the linear combination coefficients for each sub-band can be fed back to the gNB as part of the CSI report. The 2N₁N₂×N₃ codebook per layer l can take on the form

$${W}_{l} = {W}_{1} {W}_{2 , l} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ 1 {e}^{j \frac{2 π m}{{O}_{2} {N}_{2}}} … {e}^{j \frac{2 π m ( ( {N}_{2} - 1 )}{{O}_{2} {N}_{2}}} ] ,$$

$${v}_{l , m} = {[ {u}_{m} {e}^{j \frac{2 π l}{{O}_{2} {N}_{2}}} {u}_{m} … {e}^{j \frac{2 π l ( ( {N}_{1} - 1 )}{{O}_{1} {N}_{1}}} {u}_{m} ]}^{T} ,$$

$$B = [ {v}_{{l}_{0} , {m}_{0}} {v}_{{l}_{1} , {m}_{1}} … {v}_{{l}_{L - 1} , {m}_{L - 1}} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Note that O₁, O₂ oversampling factors can be assumed for the 2D DFT matrix from which matrix B is drawn. Note that W₁ can be common across all layers. W_{2,l} is a 2L×N₃ matrix, where the i^{th} column corresponds to the linear combination coefficients of the 2L beams in the i^{th} sub-band. Only the indices of the L selected columns of B can be reported, along with the oversampling index taking on O₁O₂ values. Note that W_{2,l} can be independent for different layers.

In some wireless communications systems, details are provided for NR Type-II port selection codebook. For instance, for Type-II Port Selection codebook, K (where K≤2N₁N₂) beamformed CSI-RS ports can be utilized in DL transmission, in order to reduce complexity. The K×N₃ codebook matrix per layer takes on the form

$${W}_{l} = {W}_{1}^{PS} {W}_{2 , l} .$$

Here, W₂ may follow the same structure as the conventional NR Rel. 15 Type-II Codebook, and is layer specific.

$${W}_{1}^{PS}$$

is a K×2L block-diagonal matrix with two identical diagonal blocks, e.g.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ {e}_{mod ( {m}_{PS} {d}_{PS} , K / 2 )}^{( K / 2 )} {e}_{mod ( {m}_{PS} {d}_{PS} + 1 , K / 2 )}^{( K / 2 )} … {e}_{mod ( {m}_{PS} {d}_{PS} + L - 1 , K / 2 )}^{( K / 2 )} ] ,$$

where

$${e}_{i}^{( K )}$$

is a standard unit vector with a 1 at the i^{th} location. Here d_{PS} is an RRC parameter which takes on the values {1,2,3,4} under the condition d_{PS}≤min (K/2, L), whereas m_{PS} takes on the values

$$\{ 0 , … , ⌈ \frac{K}{2 {d}_{PS}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0,1, . . . ,7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] ,$$

$$[ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

In some wireless communications systems, details are provided for NR Type-I codebook. For instance, NR Rel. 15 Type-I codebook is the baseline codebook for NR, with a variety of configurations. The most common utility of Rel. 15 Type-I codebook is a special case of NR Rel. 15 Type-II codebook with L=1 for RI=1, 2, wherein a phase coupling value is reported for each sub-band, e.g., W_{2,l} is 2×N₃, with the first row equal to [1, 1, . . . , 1] and the second row equal to [e^{j2πØ}^{₀}, . . . , e^{j2πØN}^{₃₋₁}]. Under specific configurations, φ₀=φ₁= . . . =φ_{N}_{₃}₋₁, e.g., wideband reporting. For RI>2, different beams are used for each pair of layers. NR Rel. 15 Type-I codebook can be depicted as a low-resolution version of NR Rel. 15 Type-II codebook with spatial beam selection per layer-pair and phase combining only.

In some wireless communications systems, details are provided for NR Rel. 16 Type-I codebook. For instance, assume that a gNB is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such cases, 2N₁N₂N₃ CSI-RS ports can be utilized to enable DL channel estimation with high resolution for NR Rel. 16 Type-II codebook. In order to reduce the UL feedback overhead, a Discrete Fourier transform (DFT)-based CSI compression of the spatial domain can be applied to L dimensions per polarization, where L<N₁N₂. Similarly, additional compression in the frequency domain can be applied, where each beam of the frequency-domain precoding vectors is transformed using an inverse DFT matrix to the delay domain, and the magnitude and phase values of a subset of the delay-domain coefficients can be selected and fed back to the gNB as part of the CSI report. The 2N₁N₂×N₃ codebook per layer takes on the form

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}}\end{matrix} {u}_{m} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Note that O₁, O₂ oversampling factors are assumed for the 2D DFT matrix from which matrix B is drawn. Note that W₁ is common across all layers. W_{f} is an N₃×M matrix (M<N₃) with columns selected from a critically-sampled size-N₃ DFT matrix, as follows

$${W}_{f , l} = [ \begin{matrix}{f}_{{k}_{0}} & {f}_{{k}_{1}} & … & {f}_{{k}_{{M}^{′} - 1}}\end{matrix} ] , 0 \leq {k}_{i} \leq {N}_{3} - 1 ,$$

$${f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T} .$$

In some scenarios the indices of the L selected columns of B are reported, along with the oversampling index taking on O₁O₂ values. Similarly, for W_{f,l}, the indices of the M selected columns out of the predefined size-N₃ DFT matrix are reported. In the sequel the indices of the M dimensions can be referred as the selected Frequency Domain (FD) basis indices. Hence, L, M represent the equivalent spatial and frequency dimensions after compression, respectively. Further, the 2L×M matrix \tilde{W}₂ represents the linear combination coefficients (LCCs) of the spatial and frequency DFT-basis vectors. Both \tilde{W}₂, W_{f} can be selected independent for different layers. Amplitude and phase values of an approximately β fraction of the 2LM available coefficients are reported to the gNB (β<1) as part of the CSI report. Note that coefficients with zero amplitude values are indicated via a layer-specific bitmap matrix Sₗ of size 2L×M, wherein each bit of the bitmap matrix Sₗ indicates whether a coefficient has a zero-amplitude value, wherein for these coefficients no quantized amplitude and phase values need to be reported. Since all non-zero coefficients reported within a layer are normalized with respect to the coefficient with the largest amplitude value (strongest coefficient), wherein the amplitude and phase values corresponding to the strongest coefficient are set to one and zero, respectively, and hence no further amplitude and phase information is explicitly reported for this coefficient, and an indication of the index of the strongest coefficient per layer can be reported.

Hence, for a single-layer transmission, magnitude and phase values of a maximum of [2βLM]−1 coefficients (along with the indices of selected L, M DFT vectors) can be reported per layer, leading to significant reduction in CSI report size, compared with reporting 2N₁N₂×N₃−1 coefficients' information.

For NR Rel. 16 Type-II Port Selection codebook, K (where K≤2N₁N₂) beamformed CSI-RS ports can be utilized in DL transmission, in order to reduce complexity. The K×N₃ codebook matrix per layer takes on the form

$${W}_{l} = {W}_{1}^{PS} {\tilde{W}}_{2 , l} {W}_{f , l}^{H} .$$

Here, W_{2,l} and W_{3,l} follow the same structure as the conventional NR Rel. 16 Type-II Codebook, where both are layer specific. The matrix

$${W}_{1}^{PS}$$

can be a K×2L block-diagonal matrix with the same structure as that in the NR Rel. 15 Type-II Port Selection Codebook.

The NR Rel. 17 Type-II Port Selection codebook can follow a similar structure as that of Rel. 15 and Rel. 16 port-selection codebooks, as follows

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

support free selection of the K ports, or more precisely the K/2 ports per polarization out of the N₁N₂ CSI-RS ports per polarization, e.g.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, \tilde{W}_{2,l} and W_{f,l} follow the same structure as the conventional NR Rel. 16 Type-II Codebook, however M can be limited to 1,2 only, with the network configuring a window of size N={2,4} for M=2. Moreover, the bitmap is reported unless β=1 and the UE reports all the coefficients for a rank up to a value of two.

For Rel-18 potential Type-II codebook, the time-domain corresponding to slots is further compressed via DFT-based transformation, wherein the codebook is in the following form

$${W}_{l} = {W}_{1} {{\tilde{W}}_{2 , l} ( {W}_{f , l} ⊗ {W}_{d , l} )}^{H} ,$$

where W₁, W_{f,l} follow the same structure as Rel-16 Type-II codebook, W_{d,l} is an N₄×Q matrix (Q≤N₄) with columns selected from a critically-sampled size-N₄ DFT matrix, as follows

$${W}_{d , l} = [ \begin{matrix}{d}_{{q}_{0}} & {d}_{{q}_{1}} & … & {d}_{{q}_{Q - 1}}\end{matrix} ] , 0 \leq {q}_{i} \leq {N}_{4} - 1 ,$$

$${d}_{q} = {[ \begin{matrix}1 & {e}^{- j \frac{2 π q}{{N}_{4}}} & … & {e}^{- j \frac{2 π q ( {N}_{4} - 1 )}{{N}_{4}}}\end{matrix} ]}^{T} .$$

Only the indices of the Q selected columns of W_{d,l} can be reported. Note that W_{d,l} may be layer specific, e.g., W_{d,1}≠W_{d,2}, or layer common, i.e., W_{d,1}= . . . =W_{d,RI}, where RI corresponds to the total number of layers, and the operator ⊗ corresponds to a Kronecker matrix product. Here, \tilde{W}_{2,l} is a 2L×MQ sized matrix with layer-specific entries representing the LCCs corresponding to the spatial-domain, frequency-domain and time-domain DFT-basis vectors. Thereby, a size 2L×MQ bitmap may need to be reported associated with Rel-18 Type-II codebook.

In some scenarios a codebook report is partitioned into two parts based on the priority of information reported. Each part is encoded separately (Part 1 has a possibly higher code rate). A list is presented below the parameters for NR Rel. 16 Type-II codebook.

For content of a CSI report:
Part 1: RI+Channel Quality Indicator (CQI)+Total number of coefficients
Part 2: SD basis indicator+FD basis indicator/layer+Bitmap/layer+Coefficient Amplitude info/layer+Coefficient Phase info/layer+Strongest coefficient indicator/layer

Furthermore, Part 2 CSI can be decomposed into sub-parts each with different priority (higher priority information listed first). Such partitioning can be implemented to allow dynamic reporting size for codebook based on available resources in the uplink phase. Also Type-II codebook can be based on aperiodic CSI reporting, and reported in PUSCH via Downlink Control Information (DCI) triggering (with at least one exception). Type-I codebook can be based on periodic CSI reporting (PUCCH) or semi-persistent CSI reporting (PUSCH or PUCCH) or aperiodic reporting (PUSCH).

For priority reporting for Part 2 CSI, multiple CSI reports may be transmitted with different priorities, as shown in Table 1 below. Note that the priority of the N_{Rep} CSI reports can be based on the following:
1. A CSI report corresponding to one CSI reporting configuration for one cell may have higher priority compared with another CSI report corresponding to one other CSI reporting configuration for the same cell
2. CSI reports intended to one cell may have higher priority compared with other CSI reports intended to another cell
3. CSI reports may have higher priority based on the CSI report content, e.g., CSI reports carrying L1-Reference Signal Received Power (RSRP) information have higher priority
4. CSI reports may have higher priority based on their type, e.g., whether the CSI report is aperiodic, semi-persistent or periodic, and whether the report is sent via PUSCH or PUCCH, may impact the priority of the CSI report

TABLE 1
Priority Reporting Levels for Part 2 CSI

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16‘. Part 2
subband CSI of odd subbands for CSI report 2, if
configured otherwise
. . . .
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

Accordingly, CSI reports may be prioritized as follows, where CSI reports with lower identifiers (IDs) have higher priority

$$P r {i}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting configuration index, and Mₛ: Maximum number of CSI reporting configurations
c: Cell index, and N_{cells}: Number of serving cells
k: 0 for CSI reports carrying L1-RSRP or L1-Signal-to-Interference-and-Noise Ratio (SINR), 1 otherwise
y: 0 for aperiodic reports, 1 for semi-persistent reports on PUSCH, 2 for semi-persistent reports on PUCCH, 3 for periodic reports.

In some scenarios, for triggering aperiodic CSI reporting on PUSCH, a UE can report CSI information for the network using the CSI framework in NR Release 15. The triggering mechanism between a report setting and a resource setting can be summarized in Table 2 below.

TABLE 2
Triggering mechanism between a report setting
and a resource setting

| | | Periodic | | |
|---|---|---|---|---|
| | | CSI | SP CSI | AP CSI |
| | | reporting | reporting | Reporting |
| Time | Periodic | RRC | MAC control | DCI |
| Domain | CSI-RS | configured | element (CE) | |
| Behavior | | | (PUCCH) | |
| of | | | DCI (PUSCH) | |
| Resource | SP CSI-RS | Not | MAC CE | DCI |
| Setting | | Supported | (PUCCH) | |
| | | | DCI (PUSCH) | |
| | AP CSI-RS | Not | Not | DCI |
| | | Supported | Supported | |

Further, in some scenarios:
Associated Resource Settings for a CSI Report Setting have same time domain behavior.
Periodic CSI-RS/Interference Management (IM) resource and CSI reports can be assumed to be present and active once configured by RRC
Aperiodic and semi-persistent CSI-RS/IM resources and CSI reports can be explicitly triggered or activated.
For aperiodic CSI-RS/IM resources and aperiodic CSI reports, the triggering can be done jointly by transmitting a DCI Format 0-1.
Semi-persistent CSI-RS/IM resources and semi-persistent CSI reports can be independently activated.

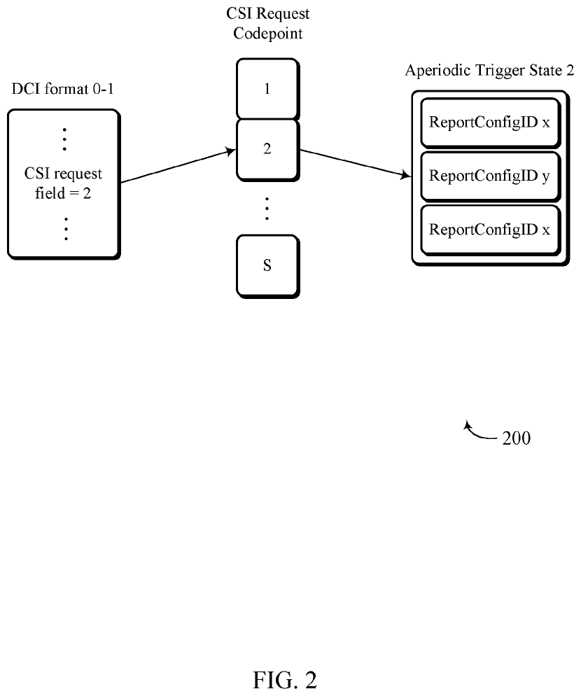

FIG. 2 illustrates an aperiodic trigger state 200 defining a list of CSI report settings. For instance, for aperiodic CSI-RS/IM resources and aperiodic CSI reports, the triggering is done jointly by transmitting a DCI Format 0-1. The DCI Format 0_1 contains a CSI request field (0 to 6 bits). A non-zero request field points to a so-called aperiodic trigger state configured by RRC, such as illustrated in FIG. 2. An aperiodic trigger state in turn is defined as a list of up to 16 aperiodic CSI Report Settings, identified by a CSI Report Setting identifier (ID) for which the UE calculates simultaneously CSI and transmits it on the scheduled PUSCH transmission.

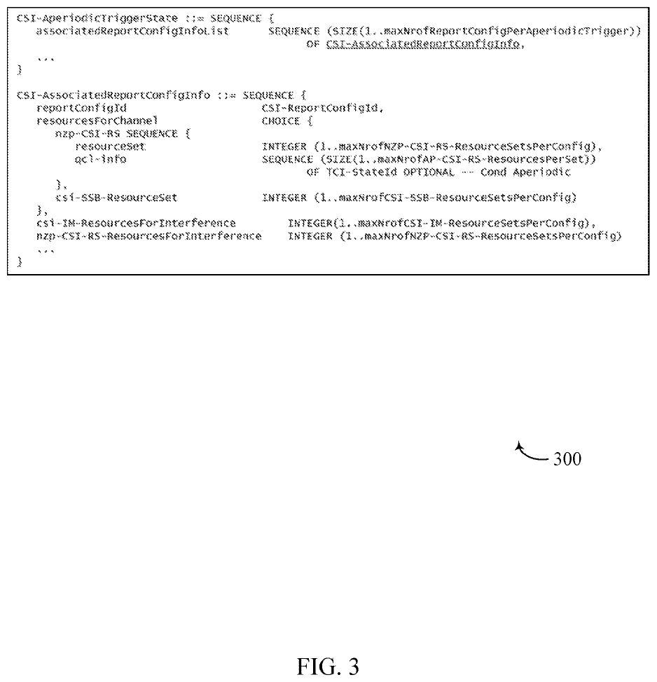

FIG. 3 illustrates an information element 300 pertaining to CSI reporting. The aperiodic trigger state indicates the resource set and quasi co-located (QCL) information. For instance, when the CSI Report Setting is linked with aperiodic Resource Setting (e.g., including multiple Resource Sets), the aperiodic non-zero power (NZP) CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the QCL source to use is also configured in the aperiodic trigger state. The UE considers that the resources used for the computation of the channel and interference can be processed with the same spatial filter e.g. quasi-co-located with respect to “QCL-TypeD.”

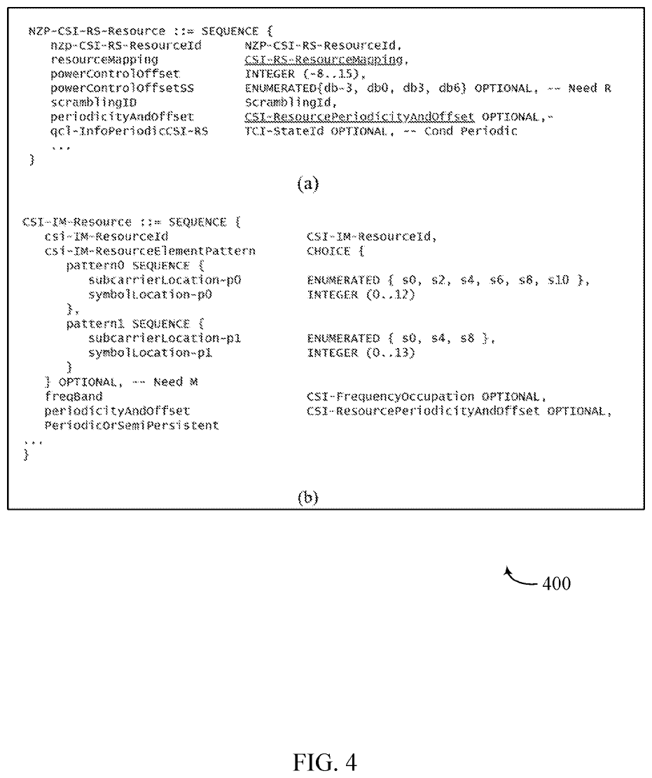

FIG. 4 illustrates an information element 400 for RRC configuration for wireless resources. The information element 400, for instance, can configure NZP-CSI-RS/CSI-IM resources. The information element 400, for instance, illustrates RRC configuration (a) for NZP-CSI-RS Resource and (b) for CSI-IM-Resource.

Table 3 summarizes the type of uplink channels used for CSI reporting as a function of the CSI codebook type.

TABLE 3
Uplink channels used for CSI reporting as a function
of the CSI codebook type

| | Periodic CSI | SP CSI | AP CSI |
|---|---|---|---|
| | reporting | reporting | reporting |
| Type I WB | PUCCH | PUCCH Format 2 | PUSCH |
| | Format | PUSCH | |
| | 2, 3, 4 | | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 | | PUCCH Format 3, 4 | |
| only | | | |

For aperiodic CSI reporting, PUSCH-based reports are divided into two CSI parts: CSI Part1 and CSI Part 2. The reason for this is that the size of CSI payload varies significantly, and therefore a worst-case UCI payload size design would result in large overhead.

CSI Part 1 has a fixed payload size (and can be decoded by the gNB without prior information) and contains the following:
RI (if reported), CSI-RS Resource Index (CRI) (if reported) and CQI for the first codeword,
number of non-zero wideband amplitude coefficients per layer for Type II CSI feedback on PUSCH.

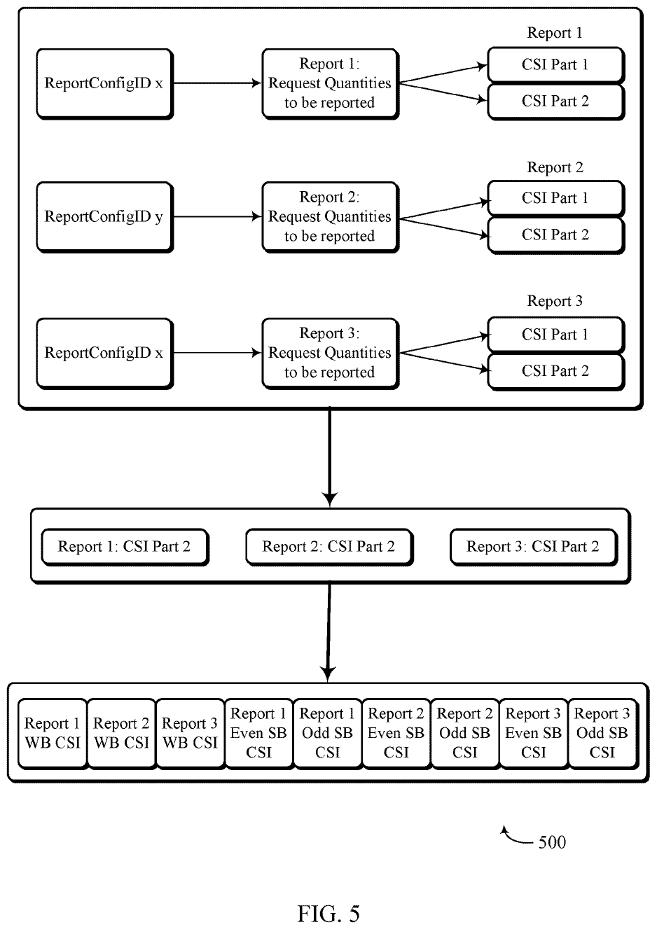

FIG. 5 illustrates a scenario 500 for partial CSI omission for PUSCH-based CSI. The scenario 500, for example, illustrates reordering of CSI Part 2 across CSI reports. CSI Part 2 can have a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 can be ordered as illustrated in the scenario 500.

As mentioned above, CSI reports can be prioritized according to:
1. time-domain behavior and physical channel, where more dynamic reports are given precedence over less dynamic reports and PUSCH has precedence over PUCCH.
2. CSI content, where beam reports (e.g., L1-RSRP reporting) has priority over regular CSI reports.
3. the serving cell to which the CSI corresponds (in case of carrier aggregation (CA) operation). CSI corresponding to the PCell has priority over CSI corresponding to Scells.
4. the reportConfigID.

A CSI report may include a CQI report quantity corresponding to channel quality assuming a maximum target transport block error rates, which indicates a modulation order, a code rate and a corresponding spectral efficiency associated with the modulation order and code rate pair. Examples of the maximum transport block error rates are 0.1 and 0.00001. The modulation order can vary from Quadrature Phase Shift Keying (QPSK) up to 1024QAM, whereas the code rate may vary from 30/1024 up to 948/1024. One example of a CQI table for a 4-bit CQI indicator that identifies a possible CQI value with the corresponding modulation order, code rate and efficiency is provided in Table 4, as follows

TABLE 4
Example of a 4-bit CQI table

| CQI | | code rate x | |
|---|---|---|---|
| index | modulation | 1024 | efficiency |
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

A CQI value may be reported in two formats: a wideband format, wherein one CQI value is reported corresponding to each PDSCH transport block, and a subband format, wherein one wideband CQI value is reported for the entire transport block, in addition to a set of subband CQI values corresponding to CQI subbands on which the transport block is transmitted. CQI subband sizes are configurable, and depends on the number of PRBs in a bandwidth part, as shown in Table 5, as follows:

TABLE 5
Configurable subband sizes for a given bandwidth part (BWP) size

| Bandwidth part (PRBs) | Subband size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, subband CQI values are reported in a full form, e.g., using 4 bits for each subband CQI based on a CQI table, e.g., Table 4. If the higher layer parameter cqi-BitsPerSubband in CSI-ReportConfig is not configured, for each subband s, a 2-bit sub-band differential CQI value is reported, defined as:

$$Sub - band Offset level ( s ) = sub - band CQI index ( s ) - wideband CQI index .$$

The mapping from the 2-bit sub-band differential CQI values to the offset level is shown in Table 6, as follows:

TABLE 6
Mapping subband differential CQI value to offset level

| Sub-band differential CQI | Offset |
|---|---|
| value | level |
| 0 | 0 |
| 1 | 1 |
| 2 | ≥2 |
| 3 | ≤−1 |

For AI/ML-based CSI frameworks, multiple alternatives exist for the outline of the AI/ML algorithm functionality, such as:
1. The AI/ML model is trained at the UE node. This alternative may appear reasonable since the UE is the node that can seamlessly collect training data for CSI acquisition using DL pilot signals, e.g., CSI-RSs for channel measurement, however, the AI/ML model should be re-trained whenever the environment changes, e.g., change of the UE location or orientation and every training instance requires significant memory and computational complexity requirements.
2. The AI/ML model is trained at the network node. One advantage of this approach is that the network has significantly more power and computational capabilities compared with a UE node, and hence can manage training moderately complex AI/ML models, as well as store large amounts of training data. Moreover, since a network node is mostly assumed to be fixed, its coverage area is expected to be the same and hence a single AI/ML model can be applicable to UEs within a specific region of the cell for a reasonable period of time. The one challenge with this approach is related to obtaining the training data at the network node, especially for FDD systems in which the UL/DL channel reciprocity may not hold. Note that the overhead corresponding to feeding back the training data from the UE to the network should be considered as one of the metrics when assessing the efficiency of an AI/ML algorithm.

In the sequel, it can be assumed the AI/ML model is trained at the network due to the advantages corresponding to memory, computation, and cell-centric characteristics of the network-based AI/ML model computation. The challenge corresponding to obtaining the training data corresponding to the DL channel at the network side is discussed in the next section.

Assuming the AI/ML model is trained at the network, a few aspects are discussed for DL training data acquisition at the network side to enable efficient AI/ML modeling.
1. In order to maintain the robustness of the AI/ML model with respect to channel variations, DL training data should be continuously fed back to the network to keep up with changes in the environment, e.g., traffic, weather, and mobile scatterers. Note that this may not necessarily correspond to online learning; even for an offline learning algorithm a framework for obtaining new training data corresponding to channel variations should be characterized.
2. Based on the current codebook-based DL CSI feedback schemes in NR, the CSI is compressed in at least one of the spatial domain, or the frequency domain, or both. One intuitive approach would be using the codebook-based CSI feedback, e.g., Type-I and/or Type-II codebooks for obtaining the training data. One disadvantage of this approach is that the training data would include CSI feedback that is already compressed via conventional approaches, which would have detrimental effect on the AI/ML model inference accuracy. For instance, if the AI/ML model compares the output of the AI/ML model with the channel corresponding to the CSI feedback to assess its own inference accuracy, this assessment would not be precise since it is based on H′, an estimate of the channel based on a pre-defined compression, rather than H, a digitally quantized channel without further compression in spatial domain, or frequency domain. On the other hand, if the UE feeds back the training data corresponding to the DL CSI feedback without compression over spatial and/or frequency dimensions, the feedback overhead of the training data would be significant, which would beat the purpose of using the AI/ML model, which is mainly to reduce the overall CSI feedback overhead. Numerically, an AI/ML-based CSI feedback aims at minimizing the following metric:

$${min}_{\hat{H}} ‖ \hat{H} - H ‖$$

Wherein H represents a digital-domain representation of the channel matrix. On the other hand, a compressed channel H′, which represents the recovered channel after codebook-based transformation, would yield the following optimization metric

$${min}_{\hat{H}} ‖ \hat{H} - {H}^{′} ‖$$

Since H≠H′, the output of both optimizations may yield different channel estimates.

For DL CSI acquisition in NR, whether the network operates in FDD mode or Time-Division Duplexing (TDD) mode, it is unlikely that AI/ML would fully replace RS-based CSI feedback for high-resolution precoding design, since some channel parameters may vary from one time instant to another, without strong correlation across the two time instants, e.g., initial random phases of the channel. Given that, AI/ML-based CSI framework can be envisioned as means of further reducing the CSI feedback overhead compared with conventional methods, e.g., reduce the number of dominant spatial-domain basis indices, frequency/delay-domain basis indices, and time/Doppler-domain basis indices, after spatial domain transformation, frequency-domain transformation, and time-domain transformation, respectively. While current CSI feedback frameworks already provide CSI feedback overhead reduction via exploiting such transformations, the CSI dimensionality can be further reduced if a wider range of transformation techniques are pre-configured, wherein a different transformation may be selected for a given UE based on variations of the channel.

In some wireless communications systems, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some implementations, an antenna panel may include an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some scenarios, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some scenarios, a device (e.g., UE, node) antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some scenarios, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or include a duration of time over which the gNB assumes there will be no change to the mapping. A Device may report its capability with respect to the “device panel” to the gNB or network. The device capability may include at least the number of “device panels”. In one implementation, the device may support UL transmission from one beam within a panel; with multiple panels, more than one beam (one beam per panel) may be used for UL transmission. In another implementation, more than one beam per panel may be supported/used for UL transmission.

In some scenarios, an antenna port is defined such that the channel over which a symbol on the antenna port is conveyed can be inferred from the channel over which another symbol on the same antenna port is conveyed.

Two antenna ports are said to be QCL if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:

- ‘QCL-TypeA’: {Doppler shift, Doppler spread, average delay, delay
spread}
- ‘QCL-TypeB’: {Doppler shift, Doppler spread}
- ‘QCL-TypeC’: {Doppler shift, average delay}
- ‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, e.g. the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same receive beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some scenarios, a TCI-state (Transmission Configuration Indication) associated with a target transmission can indicate parameters for configuring a quasi-collocation relationship between the target transmission (e.g., target RS of demodulation (DM)-RS ports of the target transmission during a transmission occasion) and a source reference signal(s) (e.g., Synchronization Signal Block (SSB)/CSI-RS/Sounding Reference Signal (SRS)) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state includes at least one source RS to provide a reference (UE assumption) for determining QCL and/or spatial filter.

In some scenarios, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some scenarios, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based PUSCH, dedicated PUCCH resources) in a component carrier (CC) or across a set of configured CCs/BWPs.

In some scenarios, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated Physical Downlink Control Channel/Physical Downlink Shared Channel (PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

In implementations, consider that a channel between a UE and a gNB with P channel paths (index p=0, . . . , P−1) occupies N_{SB} frequency bands (index n=0, . . . , N_{SB}−1), wherein the gNB is equipped with K antennas (index k=0, . . . , K−1). The channel at a time index δ can then be represented as follows

$${h}_{k , n} ( δ ) = {\sum }_{p = 0}^{P - 1} {g}_{k , p} {e}^{j 2 π n Δ f {τ}_{p} + j 2 π k \frac{{F}_{c} d}{c} s i n {θ}_{p} + j 2 πδ \frac{{F}_{c} v}{c} {cos ϕ}_{p}}$$

$${g}_{k , p} : Complex gain of path p at antenna k$$

$$Δ f : PMI Sub - band spacing$$

$${τ}_{p} : Delay of path p$$

$${F}_{c} : Carrier Frequency$$

$$c : Speed of light$$

$$d : Antenna spacing at gNB$$

$${θ}_{p} : angular spatial displacement at the gNB antenna array corresponding to path p$$

$$δ : Time index$$

$$v : Relative speed between gNB \& UE$$

$${Φ}_{p} : Angle between the moving direction \& the signal incidence direction of path p$$

One use of AI/ML in CSI acquisition is via two-sided models, in which an encoder and decoder of an autoencoder structure are applied in different nodes (e.g., a UE 104 and a network entity 102). Unless the model training is centralized, e.g., a same node trains the encoder and decoder parts of the autoencoder, the recovered CSI data at the decoder side may be mismatched with the target CSI data at the encoder side. Given that, the CQI corresponding to the CSI data may be mismatched, leading to significant degradation in performance. Accordingly, an AI/ML-based CSI feedback mechanism is discussed in which a pre-determined reference sequence is transmitted as part of the CSI report so that the node with the decoder side can quantify the CSI reconstruction error, and hence adjust a nominal CQI value fed back by the node with the encoder side. A similar approach can be used for AI model performance monitoring and adaptation as well. Several implementations are described below. It is to be appreciated that one or more elements or features from one or more of the described implementations may be combined.

An indication of CSI training dataset can be transmitted. In one or more implementations, the CSI report comprising a reference value corresponds to a CSI report type that is configured via a CSI reporting setting. In one example, the CSI reporting setting comprises a higher-layer configuration parameter, where the higher-layer configuration parameter is set to true if the CSI report comprises at least one reference value. In another example, the CSI report comprising the reference value corresponds to a new codebook type of a CSI report corresponding to a PMI, e.g., the CSI report with a reference value corresponds to a Type-III codebook type.

Additionally or alternatively, the CSI report comprising a reference value is configured via a dedicated higher-layer reporting setting, e.g., training data reporting setting or AI reporting setting.

A two-sided AI model for CSI feedback can be used. In one or more implementations, the CSI feedback mechanism is based on a two-sided AI model, where the two-sided AI model is decomposed of an encoder part at a first of two communication nodes, and a decoder part at a second of the two communication nodes. In one example, the first of the two communication nodes is a UE, and the second of the two communication nodes is a network node (e.g., a network entity 102).

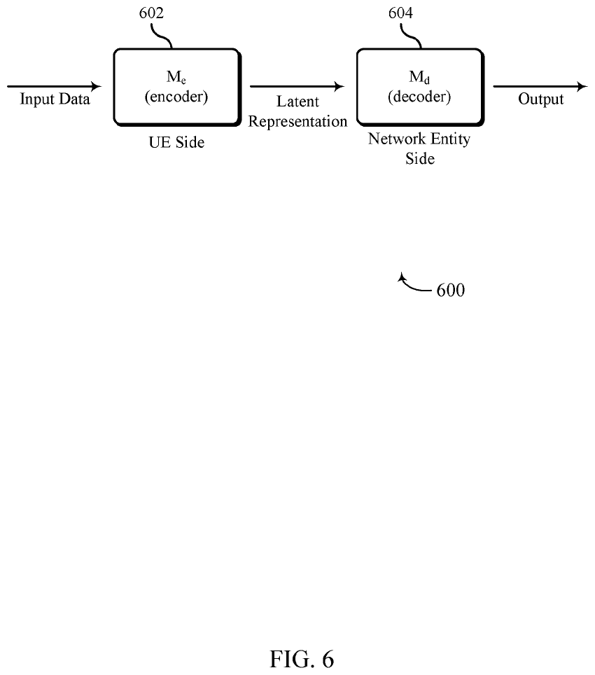

FIG. 6 illustrates an example 600 of a two-sided model with an encoder part at a first node and a decoder part at a second node in accordance with aspects of the present disclosure. The example 600 includes an encoder part 602 at a first communication node and a decoder part 604 at a second communication node. In the illustrated example 600, the encoder part is deployed in a UE and the decoder part is deployed a network entity. Additionally or alternatively, the encoder part may be deployed in a network entity and the decoder part may be deployed in a UE.

In one or more implementations, the encoder part and the decoder part of the two-sided AI model are deigned separately. In one example, the encoder part is designed or trained at the UE node, and the decoder part is designed or trained at the network node. In another example, the encoder part and the decoder part are mismatched, e.g., for an encoder and decoder functions ƒ(·), g(·) respectively, g(ƒ(x))=x+δ, where δ represents a value corresponding to a reconstruction error, a mismatch between the encoder and decoder parts, or a combination thereof.

A channel-like quantity can be reported in the CSI report. In one or more implementations, an output of the encoder corresponding to the two-sided AI model comprises two parts: a first part corresponding to CSI, and a second part corresponding to an encoded reference sequence, wherein the reference sequence is known to the communication node associated with the decoder side. In one example, the reference sequence corresponds to an eigenvector corresponding to PMI, CSI, or a combination thereof. In another example, the reference sequence corresponds to a column of a DFT-based matrix corresponding to PMI, CSI, or a combination thereof. In another example, the reference sequence is selected from a set of sequences (e.g., a pre-configured set of sequences) or a set of quantities (e.g., a set of pre-configured quantities).

Additionally or alternatively, the first part comprises an encoded sequence corresponding to a set of PMI vectors, a set of eigenvectors, a set of column vectors of a DFT-based matrix, or a combination thereof, and the second part comprises an encoded reference vector, where the reference vector shares a same set of characteristics as a subset of the set of PMI vectors, the set of eigenvectors, the set of column vectors of a DFT-based matrix, or the combination thereof. In one example, the subset of the set of PMI vectors, the set of eigenvectors, the set of column vectors of a DFT-based matrix, or the combination thereof is the same as the set of PMI vectors, the set of eigenvectors, the set of column vectors of a DFT-based matrix, or the combination thereof. In another example, the set of characteristics correspond to a size of the reference sequence compared with each member of the subset of the set of PMI vectors, the set of eigenvectors, the set of column vectors of a DFT-based matrix, or the combination thereof.

Additionally or alternatively, a CQI value reported in the CSI report is conditioned on the reference sequence being equivalent to a decoding of the encoded sequence.

Additionally or alternatively, an AI-based model monitoring outcome is based on a comparison of the reference.

A function of two quantities can be reported in the CSI report. In one or more implementations, the CSI report comprises at least two parts, a first part of the at least two parts comprising an encoded sequence that is an output of the encoder corresponding to the two-sided AI model, and a second part of the at least two parts comprising a parameter corresponding to a function of at least one quantity of the sequence prior to the encoding process. In one example, the parameter corresponds to a phase difference between two vectors of a precoding matrix or channel matrix. In another example, the parameter corresponds to a vector of a precoding matrix or channel matrix. In another example, the parameter corresponds to a measure of a mismatch of the encoder and decoder parts, a measure of a coherence between the encoder and decoder parts, or a combination thereof.

Additionally or alternatively, the parameter corresponds to a linear combination of two vectors of a precoding matrix or channel matrix. In one example, the linear combination is based on a trivial set of combination weights of a value one. In another example, the linear combination is based on a pre-determined set of combination weights, wherein the pre-determined set of combination weights is one of reported in the CSI report, higher-layer configured by the network node or pre-determined based on a rule. In another example, the two vectors correspond to two vectors of a precoding matrix, two eigenvectors of a channel, or a combination thereof.

Additionally or alternatively, a CQI value reported in the CSI report is adjusted based on a value of the parameter.

Additionally or alternatively, an AI-based model monitoring outcome is based on a value of the parameter.

Accordingly, discussed herein is a CSI feedback mechanism for two-sided AI-based CSI training models with distributed encoder/decoder designs, in which reconstruction errors due to encoder/decoder mismatch needs to be quantified for high-resolution CQI characterization as well as enhanced model monitoring. Feeding back a pre-determined reference vector as part of the encoded part of the CSI report is discussed. The node with the decoder part decodes the reference vector and compares it to the reference vector to quantify the CSI reconstruction error. Quantifying the reconstruction error can help readjust the CQI value or alternatively enhance the model monitoring and/or model adaptation performance.

Reporting a set of parameter values corresponding to a metric that measures a relative amplitude and/or phase between two encoded CSI components, e.g., phase difference and/or cosine similarity between two channel eigenvectors is also discussed. The node with the decoder part can then compare the measured metric value after decoding with the reported nominal metric value to quantify the reconstruction error.

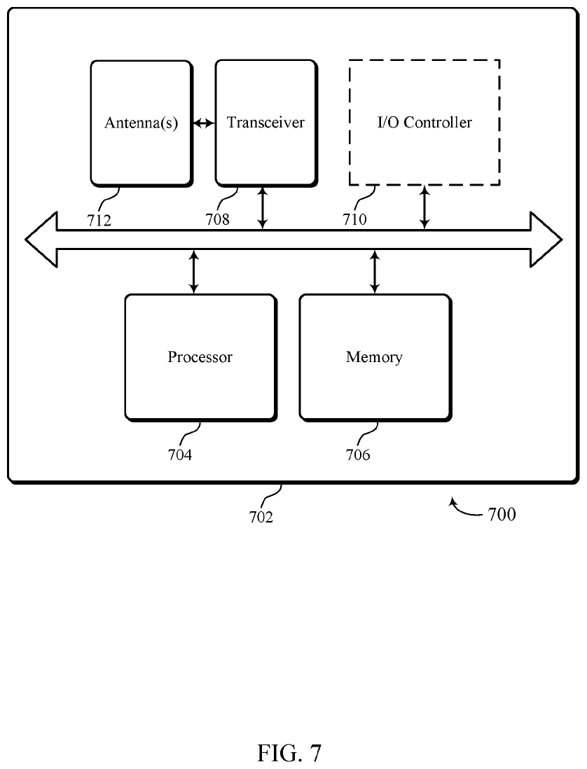

FIG. 7 illustrates an example of a block diagram 700 of a device 702 that supports reference value reporting for artificial intelligence enabled channel state information reporting framework in accordance with aspects of the present disclosure. The device 702 may be an example of a UE 104 (or a network entity 102) as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. Processor 704 may be configured as or otherwise support to: receive, from a network entity, a first signaling corresponding to a CSI RS; generate CSI feedback parameters based on a two-sided AI model including an encoder part and a decoder part, where the encoder part is deployed at the apparatus; and transmit, to the network entity, a second signaling indicating a CSI report that includes an output of the encoder part, where the output of the encoder part includes at least one of a CSI part and a reference value part.

Additionally or alternatively, the processor 704 may be configured to or otherwise support: where the reference value part is a sequence of bits corresponding to a subset of the output of the encoder part, and where a corresponding input of the encoder part is a pre-determined quantity; where the pre-determined quantity is a vector corresponding to a pre-determined eigenvector of a channel-based matrix; where the pre-determined quantity is a vector of channel coefficients corresponding to a spatial-domain basis index, a frequency-domain basis index, a time-domain basis index, or a combination thereof; where the pre-determined quantity is selected from a set of pre-configured quantities; where the reference value part is a sequence of bits corresponding to a measure of a quantity based on at least one parameter in the CSI part; where the reference value part is not a subset of the output of the encoder part; where the reference value part is equivalent to a subset of parameters of a set of parameters corresponding to the CSI part, and where the subset of parameters are an input of the encoder part; where the reference value part is a measure of a phase value based on a function of one or more channel-based parameters in the CSI part; where the reference value part corresponds to a combination of at least one parameter of a set of parameters of the CSI part; where the CSI report comprises a CQI value that is based on a fully-matched encoder and decoder pair, and where a correction factor corresponding to the CQI value is based on a comparison of the CSI part with the reference value part; where the CSI report is utilized for AI-based model monitoring, the AI-based model monitoring is based on a comparison of the CSI part with the reference value part; where the decoder part is deployed in the network entity.

For example, the processor 704 may support wireless communication at the device 702 in accordance with examples as disclosed herein. Processor 704 may be configured as or otherwise support a means for receiving, from a network entity, a first signaling corresponding to a CSI RS; generating CSI feedback parameters based on a two-sided AI model including an encoder part and a decoder part, where the encoder part is deployed at an apparatus that implements the method; and transmitting, to the network entity, a second signaling indicating a CSI report that includes an output of the encoder part, where the output of the encoder part includes at least one of a CSI part and a reference value part.

Additionally or alternatively, the processor 704 may be configured to or otherwise support: where the reference value part is a sequence of bits corresponding to a subset of the output of the encoder part, and where a corresponding input of the encoder part is a pre-determined quantity; where the pre-determined quantity is a vector corresponding to a pre-determined eigenvector of a channel-based matrix; where the pre-determined quantity is a vector of channel coefficients corresponding to a spatial-domain basis index, a frequency-domain basis index, a time-domain basis index, or a combination thereof; where the pre-determined quantity is selected from a set of pre-configured quantities; where the reference value part is a sequence of bits corresponding to a measure of a quantity based on at least one parameter in the CSI part; where the reference value part is not a subset of the output of the encoder part; where the reference value part is equivalent to a subset of parameters of a set of parameters corresponding to the CSI part, and where the subset of parameters are an input of the encoder part; where the reference value part is a measure of a phase value based on a function of one or more channel-based parameters in the CSI part; where the reference value part corresponds to a combination of at least one parameter of a set of parameters of the CSI part; where the CSI report comprises a CQI value that is based on a fully-matched encoder and decoder pair, and where a correction factor corresponding to the CQI value is based on a comparison of the CSI part with the reference value part; where the CSI report is utilized for AI-based model monitoring, the AI-based model monitoring is based on a comparison of the CSI part with the reference value part; where the decoder part is deployed in the network entity.

For example, processor 704, such as a UE 104, may support wireless communication in accordance with examples as disclosed herein. The processor 404 includes at least one controller coupled with at least one memory, and is configured to or operable to cause the processor to: receive, from a network entity, a first signaling corresponding to a CSI RS; generate CSI feedback parameters based on a two-sided AI model including an encoder part and a decoder part, where the encoder part is deployed at an apparatus that includes the processor; and transmit, to the network entity, a second signaling indicating a CSI report that includes an output of the encoder part, where the output of the encoder part includes at least one of a CSI part and a reference value part.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device 702. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

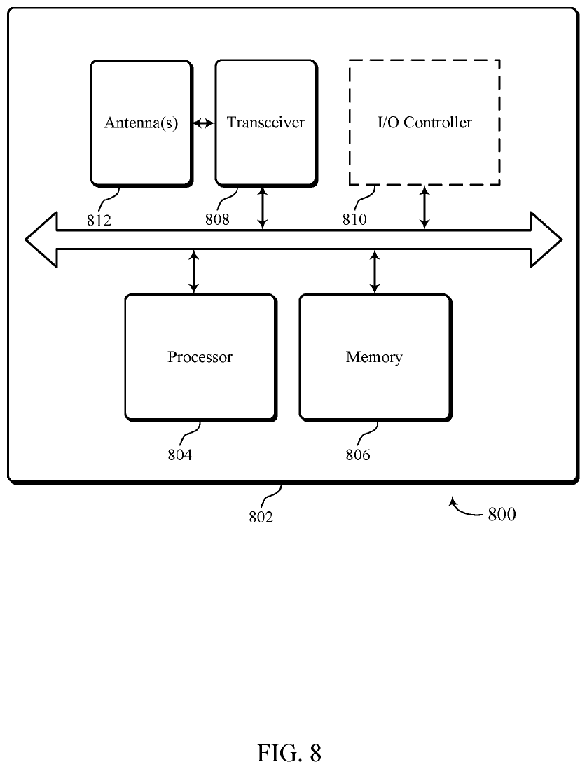

FIG. 8 illustrates an example of a block diagram 800 of a device 802 that supports reference value reporting for artificial intelligence enabled channel state information reporting framework in accordance with aspects of the present disclosure. The device 802 may be an example of a network entity 102 (or a UE 104) as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. Processor 804 may be configured as or otherwise support to: transmit, to a UE, a first signaling corresponding to a CSI RS; receive, from the UE, a second signaling indicating a CSI report that includes an output of an encoder part of a two-sided AI model having the encoder part and a decoder part, where the output of the encoder part includes at least one of a CSI part and a reference value part, and where the decoder part is deployed at the apparatus.

Additionally or alternatively, the processor 804 may be configured to or otherwise support: where the reference value part is a sequence of bits corresponding to a subset of the output of the encoder part, and where a corresponding input of the encoder part is a pre-determined quantity; where the pre-determined quantity is a vector corresponding to a pre-determined eigenvector of a channel-based matrix; where the pre-determined quantity is a vector of channel coefficients corresponding to a spatial-domain basis index, a frequency-domain basis index, a time-domain basis index, or a combination thereof; where the pre-determined quantity is selected from a set of pre-configured quantities; where the reference value part is a sequence of bits corresponding to a measure of a quantity based on at least one parameter in the CSI part; where the reference value part is not a subset of the output of the encoder part; where the reference value part is equivalent to a subset of parameters of a set of parameters corresponding to the CSI part, and where the subset of parameters are an input of the encoder part; where the reference value part is a measure of a phase value based on a function of one or more channel-based parameters in the CSI part; where the reference value part corresponds to a combination of at least one parameter of a set of parameters of the CSI part; where the CSI report comprises a CQI value that is based on a fully-matched encoder and decoder pair, and where a correction factor corresponding to the CQI value based on a comparison of the CSI part with the reference value part; where the processor is further configured to cause the apparatus to use the CSI report for AI-based model monitoring based on a comparison of the CSI part with the reference value part; where the encoder part is deployed in the UE.

For example, the processor 804 may support wireless communication at the device 802 in accordance with examples as disclosed herein. Processor 804 may be configured as or otherwise support a means for transmitting, to a UE, a first signaling corresponding to a CSI RS; and receiving, from the UE, a second signaling indicating a CSI report that includes an output of an encoder part of a two-sided AI model having the encoder part and a decoder part, where the output of the encoder part includes at least one of a CSI part and a reference value part, and where the decoder part is deployed at an apparatus that implements the method.

Additionally or alternatively, the processor 804 may be configured to or otherwise support: where the reference value part is a sequence of bits corresponding to a subset of the output of the encoder part, and where a corresponding input of the encoder part is a pre-determined quantity; where the pre-determined quantity is a vector corresponding to a pre-determined eigenvector of a channel-based matrix; where the pre-determined quantity is a vector of channel coefficients corresponding to a spatial-domain basis index, a frequency-domain basis index, a time-domain basis index, or a combination thereof; where the pre-determined quantity is selected from a set of pre-configured quantities; where the reference value part is a sequence of bits corresponding to a measure of a quantity based on at least one parameter in the CSI part; where the reference value part is not a subset of the output of the encoder part; where the reference value part is equivalent to a subset of parameters of a set of parameters corresponding to the CSI part, and where the subset of parameters are an input of the encoder part; where the reference value part is a measure of a phase value based on a function of one or more channel-based parameters in the CSI part; where the reference value part corresponds to a combination of at least one parameter of a set of parameters of the CSI part; where the CSI report comprises a CQI value that is based on a fully-matched encoder and decoder pair, and where a correction factor corresponding to the CQI value based on a comparison of the CSI part with the reference value part; further including using the CSI report for AI-based model monitoring based on a comparison of the CSI part with the reference value part; where the encoder part is deployed in the UE.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device 802. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

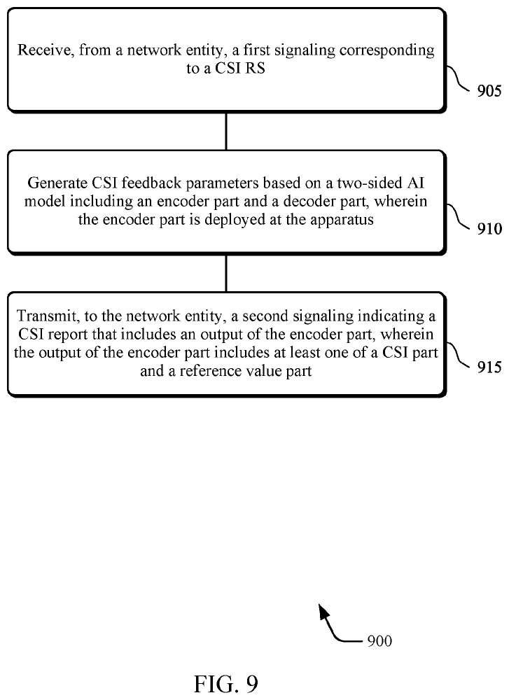

FIG. 9 illustrates a flowchart of a method 900 that supports reference value reporting for artificial intelligence enabled channel state information reporting framework in accordance with aspects of the present disclosure. The operations of the method 900 may be implemented by a device or its components as described herein. For example, the operations of the method 900 may be performed by a UE 104 (or a network entity 102) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 905, the method may include receiving, from a network entity, a first signaling corresponding to a CSI RS. The operations of 905 may be performed in accordance with examples as described herein. In some implementations, aspects of the operations of 905 may be performed by a device as described with reference to FIG. 1.

At 910, the method may include generating CSI feedback parameters based on a two-sided AI model including an encoder part and a decoder part, wherein the encoder part is deployed at the apparatus. The operations of 910 may be performed in accordance with examples as described herein. In some implementations, aspects of the operations of 910 may be performed by a device as described with reference to FIG. 1.

At 915, the method may include transmitting, to the network entity, a second signaling indicating a CSI report that includes an output of the encoder part, wherein the output of the encoder part includes at least one of a CSI part and a reference value part. The operations of 915 may be performed in accordance with examples as described herein. In some implementations, aspects of the operations of 915 may be performed by a device as described with reference to FIG. 1.

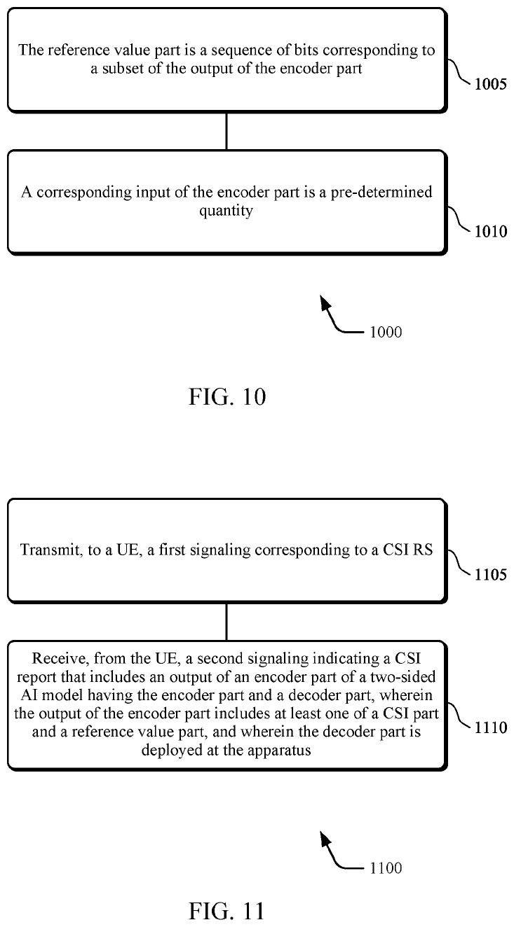

FIG. 10 illustrates a flowchart of a method 1000 that supports reference value reporting for artificial intelligence enabled channel state information reporting framework in accordance with aspects of the present disclosure. The operations of the method 1000 may be implemented by a device or its components as described herein. For example, the operations of the method 1000 may be performed by a UE 104 (or a network entity 102) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1005, the method may include the reference value part is a sequence of bits corresponding to a subset of the output of the encoder part. The operations of 1005 may be performed in accordance with examples as described herein. In some implementations, aspects of the operations of 1005 may be performed by a device as described with reference to FIG. 1.

At 1010, the method may include a corresponding input of the encoder part is a pre-determined quantity. The operations of 1010 may be performed in accordance with examples as described herein. In some implementations, aspects of the operations of 1010 may be performed by a device as described with reference to FIG. 1.

FIG. 11 illustrates a flowchart of a method 1100 that supports reference value reporting for artificial intelligence enabled channel state information reporting framework in accordance with aspects of the present disclosure. The operations of the method 1100 may be implemented by a device or its components as described herein. For example, the operations of the method 1100 may be performed by a network entity 102 (or a UE 104) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1105, the method may include transmitting, to a UE, a first signaling corresponding to a CSI RS. The operations of 1105 may be performed in accordance with examples as described herein. In some implementations, aspects of the operations of 1105 may be performed by a device as described with reference to FIG. 1.

At 1110, the method may include receiving, from the UE, a second signaling indicating a CSI report that includes an output of an encoder part of a two-sided AI model having the encoder part and a decoder part, wherein the output of the encoder part includes at least one of a CSI part and a reference value part, and wherein the decoder part is deployed at the apparatus. The operations of 1110 may be performed in accordance with examples as described herein. In some implementations, aspects of the operations of 1110 may be performed by a device as described with reference to FIG. 1.

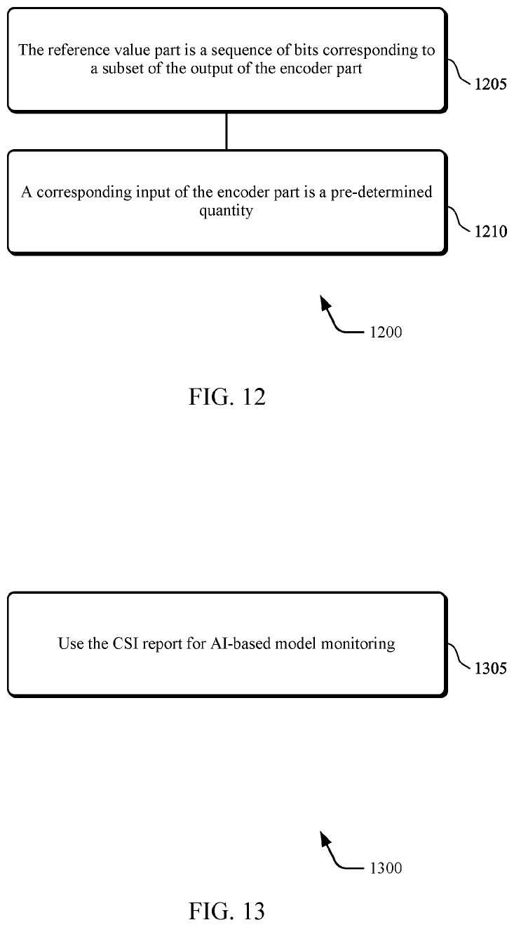

FIG. 12 illustrates a flowchart of a method 1200 that supports reference value reporting for artificial intelligence enabled channel state information reporting framework in accordance with aspects of the present disclosure. The operations of the method 1200 may be implemented by a device or its components as described herein. For example, the operations of the method 1200 may be performed by a network entity 102 (or a UE 104) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1205, the method may include the reference value part is a sequence of bits corresponding to a subset of the output of the encoder part. The operations of 1205 may be performed in accordance with examples as described herein. In some implementations, aspects of the operations of 1205 may be performed by a device as described with reference to FIG. 1.

At 1210, the method may include a corresponding input of the encoder part is a pre-determined quantity. The operations of 1210 may be performed in accordance with examples as described herein. In some implementations, aspects of the operations of 1210 may be performed by a device as described with reference to FIG. 1.

FIG. 13 illustrates a flowchart of a method 1300 that supports reference value reporting for artificial intelligence enabled channel state information reporting framework in accordance with aspects of the present disclosure. The operations of the method 1300 may be implemented by a device or its components as described herein. For example, the operations of the method 1300 may be performed by a network entity 102 (or a UE 104) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1305, the method may include using the CSI report for AI-based model monitoring. The operations of 1305 may be performed in accordance with examples as described herein. In some implementations, aspects of the operations of 1305 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a channel state information (CSI) reference signal (RS);
generate CSI feedback parameters based at least in part on a two-sided artificial intelligence (AI) model including an encoder part that is deployed at the UE; and
transmit a CSI report that includes an output of the encoder part, wherein the output of the encoder part includes at least one of a CSI part and a reference value part.

2. The UE of claim 1, wherein the reference value part is a sequence of bits that correspond to a subset of the output of the encoder part, and wherein a corresponding input of the encoder part is a pre-determined quantity.

3. The UE of claim 2, wherein the pre-determined quantity is a vector corresponding to a pre-determined eigenvector of a channel-based matrix.

4. The UE of claim 2, wherein the pre-determined quantity is a vector of channel coefficients corresponding to at least one of a spatial-domain basis index, a frequency-domain basis index, or a time-domain basis index.

5. The UE of claim 2, wherein the pre-determined quantity is selected from a set of pre-configured quantities.

6. The UE of claim 1, wherein the reference value part is a sequence of bits corresponding to a measure of a quantity based at least in part on at least one parameter in the CSI part.

7. The UE of claim 6, wherein the reference value part is not a subset of the output of the encoder part.

8. The UE of claim 6, wherein the reference value part is equivalent to a subset of parameters of a set of parameters corresponding to the CSI part, and wherein the subset of parameters are an input of the encoder part.

9. The UE of claim 6, wherein the reference value part is a measure of a phase value based at least in part on a function of one or more channel-based parameters in the CSI part.

10. The UE of claim 6, wherein the reference value part corresponds to a combination of at least one parameter of a set of parameters of the CSI part.

11. The UE of claim 1, wherein the CSI report comprises a channel quality indicator (CQI) value that is based at least in part on a fully-matched encoder and decoder pair, and wherein a correction factor corresponding to the CQI value is based at least in part on a comparison of the CSI part with the reference value part.

12. The UE of claim 1, wherein the CSI report is utilized for AI-based model monitoring, the AI-based model monitoring is based at least in part on a comparison of the CSI part with the reference value part.

13. The UE of claim 1, wherein the two-sided AI model includes a decoder part, wherein to receive the CSIRS, the at least one processor is further configured to cause the UE to receive the CSI RS from a network entity, and wherein the decoder part is deployed in the network entity.

14. A base station for wireless communication, comprising:
at least one memory; and
at least one processor coupled with the at least one memory and configured to cause the base station to:
transmit a channel state information (CSI) reference signal (RS); and
receive a CSI report that includes an output of an encoder part of a two-sided artificial intelligence (AI) model having the encoder part and a decoder part, wherein the output of the encoder part includes at least one of a CSI part and a reference value part, and wherein the decoder part is deployed at the base station.

15. The base station of claim 14, wherein the reference value part is a sequence of bits that correspond to a subset of the output of the encoder part, and wherein a corresponding input of the encoder part is a pre-determined quantity.

16. The base station of claim 14, wherein the reference value part is a sequence of bits corresponding to a measure of a quantity based at least in part on at least one parameter in the CSI part.

17. A method performed by a user equipment (UE), the method comprising:
receiving a channel state information (CSI) reference signal (RS);
generating CSI feedback parameters based at least in part on a two-sided artificial intelligence (AI) model including an encoder part that is deployed at the UE; and
transmitting a CSI report that includes an output of the encoder part, wherein the output of the encoder part includes at least one of a CSI part and a reference value part.

18-20. (canceled)

21. The method of claim 17, wherein the reference value part is a sequence of bits that correspond to a subset of the output of the encoder part, and wherein a corresponding input of the encoder part is a pre-determined quantity.

22. A method performed by a base station, the method comprising:
transmitting a channel state information (CSI) reference signal (RS); and
receiving a CSI report that includes an output of an encoder part of a two-sided artificial intelligence (AI) model having the encoder part and a decoder part, wherein the output of the encoder part includes at least one of a CSI part and a reference value part, and wherein the decoder part is deployed at the base station.

23. The method of claim 22, wherein the reference value part is a sequence of bits corresponding to a measure of a quantity based at least in part on at least one parameter in the CSI part.
